(19) United States
(12) Patent Application Publication
(10) Pub. No.: US 2007/0246892 A1
(43) Pub. Date: Oct. 25, 2007

(54) Support Ring and Axis Leadthrough

(76) Inventors: Per-Olof Andersson, Vasterhaninge (SE); Rifet Mehmedovic, Tumba (SE); Henrik Nedlich, Sundbyberg (SE); Per Gehrke, Stockholm (SE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/577,669

(22) PCT Filed: Oct. 12, 2005
(86) PCT No.: PCT/SE05/01528

§ 371 Date: Apr. 20, 2007

(30) Foreign Application Priority Data
Oct. 21, 2004 (SE) 0402549-0

(51) Int. Cl. F16J 15/34; F16F 15/10

(52) U.S. Cl. 277/399; 267/141; 277/407

(57) ABSTRACT

The invention relates to a support ring for stabilizing an axle packing. The axle packing is presumed to include an axle-circumscribing element whose outer delimitation surface is essentially ring shaped. The support ring has an inner delimitation surface, which forms an opening for receiving the axle-circumscribing element. The support ring is adapted to be stationary mounted in an axle housing in such a manner that the inner delimitation surface of the support ring adjoins the ring shaped outer delimitation surface of the axle-circumscribing element with a gap thereto. The inner delimitation surface is configured such that an inner diameter of the support ring along this surface varies between a maximal opening dimension and a minimal opening dimension.

### THE TECHNICAL FIELD OF THE INVENTION AND PRIOR ART

The present invention relates generally to improvements of the characteristics of axle packings. Specifically, the invention relates to a support ring according to the preamble of claim 1 and an axis lead-through according to the preamble of claim 6 respectively.

At axis lead-throughs, especially for the driveline of a marine vessel, it is important to both minimize any undesired axle movements and to accomplish a sealing towards a liquid medium. Any axle movements, axial and/or radial, must not risk the sealing towards the liquid medium, which typically is represented by water. Furthermore, in water jet units for example, it is desirable to have a relatively large flow of water passing the actual axle packing during operation of the vessel, since such a flow contributes to keeping the area free from sediments, biological organisms etc. The desired water flow can be obtained via a pump means, which for instance is connected to an engine's cooling water system.

The international patent application WO03/064885 describes a bellow-shaped spring element for pressing an essentially stationary sealing element against a rotating sealing element. The spring element is adapted to circumscribe a rotating axle in a sealing manner, and configured such that axial movements of the axle are allowed, without the force that presses the sealing elements together becoming critically low or high.

However, the known bellow-shaped spring is incapable of handling any radial axle movements satisfactory. Naturally, the driveline axle of a ship is exposed to radial forces in many different operating conditions and may, as a result thereof, be more or less displaced in a radial direction. For example, if the ship body is formed by a material having a relatively low torsional rigidity, such as glass fiber, the body itself may be temporarily deformed to some degree in connection with acceleration, deceleration or sea. This, in turn, may lead to that the axis lead-throughs of the drive line are displaced radially relative to the transmission axle(s) being included in the driveline, which may lead to that the axle packings leak in water.

A theoretically possible solution to minimize this kind of undesired effects would be to have a support ring for the essentially stationary sealing element fit tightly against this element and be comparatively unelastic, such that only very small radial axle movements were allowed at the axle packing. However, this would result in strong vibrations in the ship body (or any other object into which the axle is fitted) and furthermore cause large material strain in the form of shear and torsion forces in respect of the structural members concerned.

If instead the support ring were made of a relatively flexible material (e.g. rubber or plastic) these vibrations and the material strain could be reduced considerably. However, the necessary fitting of the support ring towards the sealing element would prevent a water flow from passing the axle packing. Moreover, a flexible support ring of this type would complicate the axle movements that are allowed by means of the above-mentioned bellow-shaped spring element, since the essentially stationary sealing element (i.e. the non-rotating element) then risks becoming stuck due to so-called slip-stick movements. Namely, if the axle is displaced in an axial direction as well as in a radial direction, for example because of a slight bending of the axle, the sealing element may wedge up against the support ring like a drawer of a chest of drawers.

### SUMMARY OF THE INVENTION

The object of the present invention is therefore to alleviate the above-mentioned problems and accomplish a solution, which is capable of handling slight radial axle movements relative to an axis lead-through without deteriorating an adjacent axle packing, or resulting in strong vibrations, at the same time as a rich liquid flow is allowed to pass the axle packing.

According to one aspect of the invention, this object is achieved by the support ring as initially described, which is characterized in that the inner delimitation surface is configured such that an inner diameter of the support ring along this surface varies between a maximal opening dimension and a minimal opening dimension.

An important advantage by this design is that the varying opening dimension, on one hand, stabilizes the sealing element, and on the other hand, avoids slip-stick movements. This is possible because the sealing element may be caused to fit against those points of the support ring where the opening dimension is minimal at the same time as the axle circumscribing element may be angled relative to the support ring along those surface segments where the opening dimension is larger than the minimal dimension. Naturally, liquid may also pass the support ring through the gaps that are formed between each fitting point (i.e. along the surface segments where the opening dimension not is minimal).

According to one preferred embodiment of this aspect of the invention, the inner delimination surface is wave shaped, such that the maximal opening dimension correspond to a wave trough and the minimal opening dimension corresponds to a wave crest. Namely, for arbitrary wave shape, this configuration of the inner delimitation surface enables an adequate adjustment between the stability of the axle packing and the desired liquid flow to pass the same.

According to another preferred embodiment of this aspect of the invention, the inner delimitation surface includes an odd number of wave crests, however at least three. Thereby, the risk of slip-stick movements is further reduced, since diametrically opposing fitting points between the axle circumscribing element and the support ring are thus avoided.

According to yet another preferred embodiment of this aspect of the invention, the support ring is essentially composed of an elastic material, such an elastomer. This choice of material provides the support ring with exceptional cushioning and resistance characteristics.

According to another aspect of the invention, the object is achieved by the axis lead-through initially described, which is characterized in that the axle housing includes the proposed support ring and that this ring is mounted in the axle housing, such that the ring's inner delimitation surface adjoins the outer delimitation surface of the axle circumscribing element with a gap thereto. This is advantageous because the packing element thereby becomes stabilized without risking any slip-stick movements between the axle circumscribing element and the support ring. Moreover, a liquid flow is allowed to pass the support ring.

According to one preferred embodiment of this aspect of the invention, the gap is adapted to allow a specific flow of the liquid medium to pass the support ring. The gap's total cross section area thus has a particular size.

According to another preferred embodiment of this aspect of the invention, the gap is accomplished by the inner delimitation surface of the support ring being wave shaped. A maximal gap between the inner delimitation surface and the ring shaped outer delimitation surface of the axle-circumscribing element is here given by a wave trough, while a minimal gap is given by a wave crest. Such a design is advantageous because the wave shape may be adapted to the requirements of the specific implementation in respect of stability and cushioning, at the same time as a desired liquid flow passing the support ring is allowed. Particularly, the support ring may be configured such that a main gap space is formed between the ring shaped outer delimitation surface of the axle circumscribing element and a surface segment between two subsequent wave crests of the support ring's outer delimitation surface. Additionally, the wave shape is adapted such that a combined cross section area of the main gap space between all the wave crests of the support ring allows the above-mentioned liquid flow.

According to yet another preferred embodiment of this aspect of the invention, the wave shape is adapted to a particular main rotation frequency interval, such that radial vibrations of the axle-circumscribing element are attenuated optimally. This, of course, results in an improved reduction of the vibrations for a particular implementation, where the axle mainly is caused to rotate within said interval.

According to still another preferred embodiment of this aspect of the invention, the axis lead-through includes a non-rotating spring element, which is essentially stationary relative to the axle housing. The spring element is adapted to press a first sealing surface of an essentially stationary part of the axle packing against a second sealing surface of a rotating part of the axle packing, which is connected to the axle. Thereby, also radial displacements of the axle are allowed without risking the quality of the axle packing. The spring element preferably has a bellow-shaped profile, since this design efficiently guarantees the sealing towards the axle as such.

In addition to what has been mentioned above, the proposed solution improves the stability of the axle packing by enabling a relatively large amount of liquid to be constantly kept encapsulated in a space where the spring element is positioned in such a manner that the liquid surrounds the spring element and by means of its inertia accomplishes a stabilizing effect. This, in turn, is possible because the liquid flow pass the proposed support ring can be determined relatively accurately.

### BRIEF DESCRIPTION OF THE DRAWINGS

The invention will now be explained in further detail with reference to preferred embodiments, which are described as examples, and referring to the attached drawings.

FIG. 1 shows an axis lead-through according to one embodiment of the invention, and

FIG. 2 illustrates one example of a proposed support ring.

### DETAILED DESCRIPTION OF PREFERRED EMBODIMENTS OF THE INVENTION

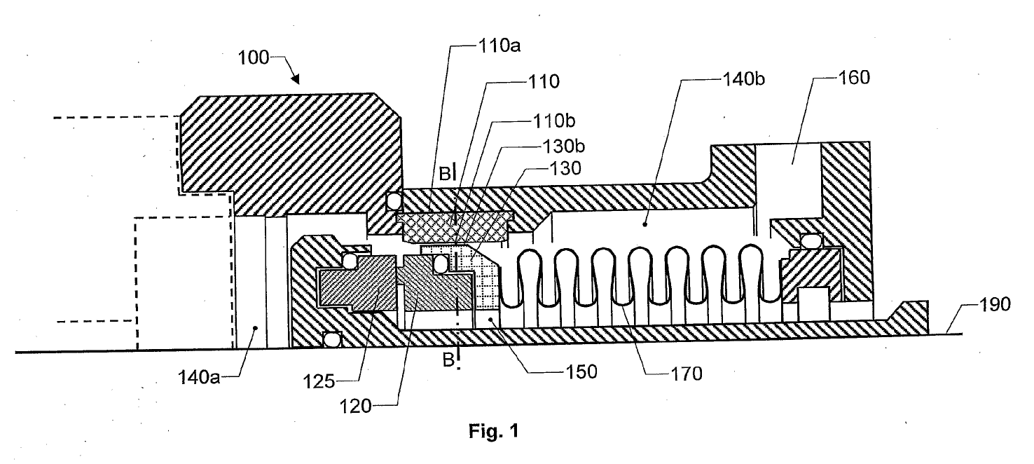

An axis lead-through according to one embodiment of the invention is shown in FIG. 1. The axis lead-through includes an axle house 100 and an axle packing. The axle packing in turn includes at least one axle-circumscribing element 130 having a ring shaped outer delimitation surface 130b. Additionally, the axle packing preferably includes an essentially stationary part 120 and a rotating part 125, which are pressed against one another. Alternatively, however, the stationary part 120 and the axle-circumscribing element 130 may be integrated into one unit.

In any case, the axle packing is adapted to prevent a liquid medium located in a first space 140a in connection to a rotating axle 190 on a first side of the axle packing from reaching a dry space 150 on a second side of the axle packing. A support ring 110 is mounted in the axle housing 100, such that an inner delimitation surface 110b of the ring 110 adjoins the ring shaped outer delimitation surface 130b of the axle-circumscribing element 130 with a gap thereto. This gap allows the liquid medium to pass the axle-circumscribing element 130 from a second space 140b to the first space 140a.

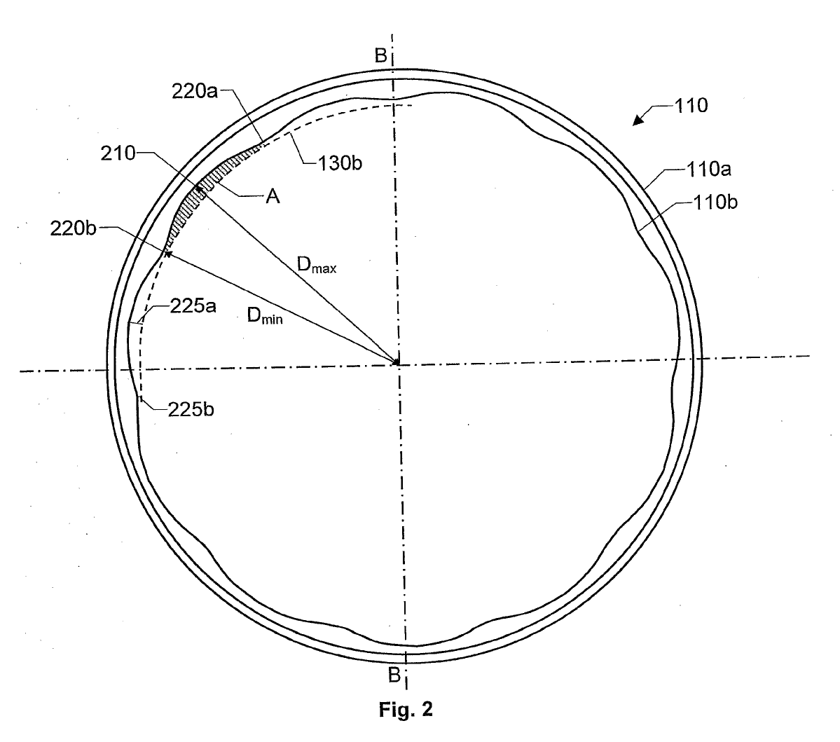

FIG. 2 shows a side view over the support ring 110 along the cross section B-B in the FIG. 1. The outer delimitation surface 130b of the axle-circumscribing element 130 is here schematically illustrated by means of a dashed line. As can be seen in the FIG. 2, the gap between the inner delimitation surface 110b of the support ring 110 and the ring shaped outer delimitation surface 130b of the axle circumscribing element 130 varies between a maximal value 225a and a minimal value 225b, which may correspond to a zero gap. Preferably, the gap is adapted to allow a specific flow of the liquid medium pass the support ring 110. Namely, thereby, a particular rinsing rate of the second space 140b is guaranteed, such that the space can be held free from sediments, biological organisms etc. Preferably, liquid medium, e.g. water, is supplied to the space 140b from the cooling system of an engine. Typically, cooling water from the engine (or engines) that propel/s the axle 190 is thus supplied via a passage 160 into the space 140b. The liquid flow to the space 140b thereby becomes essentially proportional to the rotation speed of the engine(s) in question. Since this rotation speed varies substantially from close to zero, at idle, to relatively high values, for example when accelerating quickly, the liquid flow into the space 140b is sometimes very uneven. Consequently, it is desirable to store a certain amount of liquid inside the space 140b to serve as a buffer to accommodate such flow variations. At the same time, a particular minimum flow passing the support ring 110 must be guaranteed in order to tolerate a longer period of high rotation speed, without building up an unacceptably high pressure in the space 140b.

According to the invention, the inner delimination surface 110b of the support ring 110 preferably has a wave shape, for example according to the type of curvature illustrated in the FIG. 2, i.e. with relatively smooth transitions between a maximal opening dimension Dₘₐₓ and a minimal opening dimension Dₘᵢₙ of the opening that is formed by the inner delimitation surface 110b of the support ring 110. For example, in maritime applications this is advantageous with regard to hydrodynamic effects, such as the forming of vortices. According to the invention, however, arbitrary alternative wave shapes are likewise conceivable, such as saw-tooth shapes or step shapes having one or more distinct steps between a larger and a smaller inner diameter along the surface that constitutes the inner delimitation surface 110b of the support ring 110. According to one preferred embodiment of the invention, the wave shape is also adapted to attenuate radial vibrations of the axle-circumscribing element 130 with respect to a main rotation frequency interval of the axle 190. Irrespective of the specific wave shape, the maximal gap 225a between the inner delimitation surface 110b and the outer delimitation surface 130b of the axle circumscribing element 130 is here given by a wave trough 210, and a minimal gap 225b between the inner delimitation surface 110b and the outer delimitation surface 130b of the axle circumscribing element 130 is given by a wave crest 220a and 220b respectively.

Furthermore, the material of the support ring 110 is preferably selected such that its spring constant and cushioning are optimized to a main rotation frequency interval of the axle 190. The support ring 110 is preferably composed of an elastic material. Preferably, the support ring 110 therefore includes an elastomer, e.g. rubber in the form of for instance polyisoprene (or natural rubber), polybutadiene, polyisobutylene and polyurethane, or plastic in the form of for instance polyethylene, polypropylene, polystyrene, polyester, polycarbonate, polyvinyl chloride (PVC), polytetrafluoro ethylene (PFTE) and polymethylmethacrylate

According to one embodiment of the invention, the support ring 110 is configured such that a main gap A is formed between the surface 130b and a surface segment between two consecutive wave crests 220a and 220b respectively of the surface 110b.

Moreover, the wave shape is configured such that a combined cross section area of the main gap A between all the wave crests of the support ring 110 allows said specific flow. In the example illustrated in the FIG. 2, this combined cross section area is thus 11A, since the support ring 110 has 11 wave crests (and thus also 11 wave throughs). The number of wave crests is an optimizing parameter which i.a. depends on the dimension of the axle 190 and the viscosity of the liquid medium. In any case, the inner delimitation surface 110b preferably has an odd number of wave crests, where the number is equal to at least three.

According to one preferred embodiment of the invention, the axis lead-through also includes a non-rotating spring element 170 (see the FIG. 1), which is essentially stationary relative to the axle housing 100. The spring element 170 is adapted to press a first sealing surface of the essentially stationary part 120 against a second sealing surface of the rotating part 125 of the axle packing. The spring element 170 has a bellow-shaped profile, which circumscribes the axle 190 in a sealing manner. Namely thus, the liquid medium in the space 140b is prevented from reaching the dry space 150 on the other side of the axle packing.

The invention is not restricted to the described embodiments in the figures, but may be varied freely within the scope of the following claims.

1. Support ring for stabilizing an axle packing, which axle packing comprises an axle circumscribing element whose outer delimitation surface is essentially ring shaped, the support ring having an inner delimitation surface which forms an opening for receiving the axle circumscribing element, and the support ring is adapted to be stationary mounted in an axle housing in such a manner that the inner delimitation surface of the support ring adjoins the ring shaped outer delimitation surface of the axle circumscribing element with a gap thereto, characterized in that
the inner delimitation surface is configured such that an inner diameter of the support ring along this surface varies between a maximal opening dimension and a minimal opening dimension.

2. Support ring according to claim 1, characterized in that the inner delimitation surface is wave shaped, said maximal opening dimension corresponding to a wave trough and said minimal opening dimension corresponding to a wave crest.

3. Support ring according to claim 2, characterized in that the inner delimitation surface comprises an odd number of wave crests.

4. Support ring according to claim 3, characterized in that the number of wave crests is at least three.

5. Support ring according to claim 1, characterized in that it is essentially composed of an elastic material.

6. Axis lead-through comprising an axle housing and an axle packing which in turn includes an axle circumscribing element having a ring shaped outer delimitation surface, the axle packing being adapted to prevent a liquid medium located in connection to a rotating axle on a first side of the axle packing from reaching a second side of the axle packing, characterized in that
the axle housing comprises a support ring according to any one of the preceding claims, the support ring being mounted in the axle housing such that its inner delimitation surface adjoins the ring shaped outer delimitation surface of the axle circumscribing element with a gap thereto.

7. Axis lead-through according to claim 6, characterized in that said gap is adapted to allow a specific flow of the liquid medium to pass the support ring

8. Axis lead-through according to claim 7, characterized in that the inner delimitation surface of the support ring is wave shaped, wherein a maximal gap between the inner delimitation surface and the ring shaped outer delimitation surface of the axle circumscribing element is provided by a wave trough, and a minimal gap between the inner delimitation surface and the ring shaped outer delimitation surface of the axle circumscribing element is provided by a wave crest.

9. Axis lead-through according to claim 8, characterized in that the support ring is arranged such that a main gap space is formed between the ring shaped outer delimitation surface of the axle circumscribing element and a surface segment between two subsequent wave crests of the inner delimitation surface of the support ring, and the wave shape is configured such that a combined cross section area of the main gap space between all the wave crests of the support ring allows said specific flow.

10. Axis lead-through according to claim 8, characterized in that the wave shape is adapted to attenuate radial vibrations of the axle circumscribing element with respect to a main rotation frequency interval of the axle.

11. Axis lead-through according to claim 6, characterized in that it comprises a spring element being non-rotating relative to the axle housing, the element being adapted to press a first sealing surface of an essentially stationary part of the axle packing against a second sealing surface of a rotating part of the axle packing which is connected to the axle.

12. Axis lead-through according to a claim 11, characterized in that the spring element has a bellow-shaped profile which is adapted to circumference the axle.
